(19) United States
(12) Patent Application Publication
(10) Pub. No.: US 2025/0139845 A1
(43) Pub. Date: May 1, 2025

(54) Context-Aware Augmented Reality Based on Learned Object Relationships and Properties

(71) Applicant: Kaleidoco Inc., New York, NY (US)

(72) Inventors: Silas Merlin TOMS, Oakland, CA (US); Cassandra ROSENTHAL, New York, NY (US)

(73) Assignee: Kaleidoco Inc., New York, NY (US)

(21) Appl. No.: 18/934,019

(22) Filed: Oct. 31, 2024

Related U.S. Application Data
(63) Continuation of application No. 63/594,710, filed on Oct. 31, 2023.
(63) Continuation of application No. 63/594,723, filed on Oct. 31, 2023.
(63) Continuation of application No. 63/594,738, filed on Oct. 31, 2023.

(51) Int. Cl. G06T 11/00; G06F 16/28; G06F 40/30; G06V 10/70; G06V 20/20

(52) U.S. Cl. CPC G06T 11/00; G06F 16/288; G06V 10/768; G06V 20/20; G06F 40/30

(57) ABSTRACT

A system may generate an AR display in which one or more virtual objects are to be overlaid onto a real world environment, access an Augmented Unification (AU) object comprising one or more properties that define a context of the real world environment based on image recognition performed on the real world environment, identify a virtual object and one or more characteristics of the virtual object based on the AU object, define a behavior of the virtual object with respect to the physical environment based on the one or more context-driven data elements, receive a virtual object to augment the electronic display and one or more permissible actions that can be used based on contextual data, update the electronic display to include the virtual object, and cause an interaction between the physical object and the virtual object based on the one or more permissible actions to be displayed.

### CROSS-REFERENCE TO RELATED APPLICATIONS

This application claims priority to U.S. Provisional Patent Application Ser. No. 63/594,710, filed on Oct. 31, 2023, entitled “DATA ACQUISITION PLATFORM AND STORAGE ARCHITECTURES FOR LEARNING OBJECT RELATIONSHIPS AND PROPERTIES”; U.S. Provisional Patent Application Ser. No. 63/594,723, filed on Oct. 31, 2023, entitled “PLATFORM FOR LEARNING OBJECT RELATIONSHIPS AND PROPERTIES FOR AUGMENTED REALITY”; and U.S. Provisional Patent Application Ser. No. 63/594,738, filed on Oct. 31, 2023, entitled “CONTEXT-AWARE AUGMENTED REALITY BASED ON LEARNED OBJECT RELATIONSHIPS AND PROPERTIES”, the entire contents of each of which are incorporated by reference herein.

### BACKGROUND

Augmented Reality (AR) is display technology in which a computer-generated object is overlaid onto a real world view. AR technology is used to enhance and augment our perception of the physical world, allowing us to interact with digital content in real-time while still being able to see and interact with the physical environment. AR adds a layer of digital content on top of the physical environment, which can include graphics, text, audio, and video, among others. Mixed Reality (MR) is a subset of AR in which a user can interact with either real world or computer-generated objects. For purposes of discussion, MR is a subset of and included within AR unless expressly noted otherwise. Virtual Reality (VR) is a completely simulated environment having only computer-generated objects.

Basic systems may overlay an AR image such as a character in the AR display without respect to the real world on which the AR display is overlaid. Some AR systems can recognize an anchor in the real world and overlay an AR image on top of the anchor. For example, an AR system may recognize a predefined encoding such as a QR code and then overlay information in an area surrounding the QR code. More sophisticated systems may overlay graphical instructions such as for augmenting navigation displays. However, many of these systems do not have interactivity between the AR image and the real world. This results in AR images that do not interact in an intuitive way with the real world and/or in a way that allows users to contextually interact with the virtual or physical environment.

These and other issues may exist in augmented reality systems.

### BRIEF DESCRIPTION OF THE DRAWINGS

Features of the present disclosure may be illustrated by way of example and not limited in the following figure(s), in which like numerals indicate like elements, in which:

FIG. 1 illustrates an example of a system environment 100 for learning relationships and properties of data objects for context-aware AU systems for intelligent interactions between objects in an AR display;

FIG. 2 illustrates an example of a schematic architecture of a data acquisition subsystem that acquires data from various data sources for learning data object properties and relationships;

FIG. 3 illustrates an example of a schematic architecture of an object learning subsystem for learning data object properties and relationships;

FIG. 4 illustrates an example of a schematic architecture of a data lake for processing content from the data landing;

FIG. 5 illustrates an example of a schematic architecture of an interface for the learned data objects for AR applications;

FIG. 6 illustrates a flowchart of an example of a method of acquiring content and storing learned augmented unification data from the content in a storage architecture that enables efficient processing;

FIG. 7 illustrates a flowchart of an example of a method of learning augmented unification data from content for augmented reality systems;

FIG. 8 illustrates a flowchart of an example of a method of context-aware augmented reality using augmented unification data learned from content; and

FIG. 9 illustrates an example of a computer system that may be implemented by devices illustrated in FIGS. 1-5.

### DETAILED DESCRIPTION

The disclosure relates to systems and methods of learning object relationships and properties from multivariate content for improved context-based AR. Content may be accessed from various content sources to learn augmented unification (AU) data. The AU data may include object relationships, attributes, and/or contextual information such as, among others, location data. Generally speaking, AU generally is a technology process that integrates digital information or virtual objects into the real world in a way that seamlessly blends with the user's environment based on the learned AU data. AU generates a cohesive and unified experience where the virtual and physical elements coexist and interact naturally.

Augmented unification involves aligning and synchronizing virtual content with the user's perception of the real world, making it appear as if the digital objects or information are part of their immediate surroundings. This integration can be achieved through various techniques, such as marker-based tracking, image recognition, or spatial mapping. By implementing augmented unification, AR applications can provide users with an enhanced and immersive experience. Users can view and interact with virtual objects as if they were physically present in the real world, allowing for more intuitive and engaging interactions. For example, users can place virtual furniture in their living room to see how it fits or visualize architectural models overlaid onto real world locations to assess their design.

The goal of augmented unification is to bridge the gap between the digital and physical realms, enabling users to seamlessly perceive and interact with digital content in their immediate environment. AU may be applicable to various fields, including gaming, education, healthcare, retail, and industrial applications, among others.

In augmented unification, object relationships and properties play a fundamental role in seamlessly integrating virtual and real world objects. These relationships govern the spatial positioning, orientation, and scaling of virtual objects relative to one another and the physical environment. By accurately establishing these relationships, augmented reality applications can create a cohesive and immersive experience.

Furthermore, object relationships and properties extend beyond the placement of virtual objects. They also encompass how virtual objects interact with real world elements. For example, virtual objects can respond to physical surfaces or objects by adhering to their contours or reflecting their properties. This level of interaction adds depth and realism to the augmented reality experience.

Understanding the properties of real world objects is essential for defining the behavior of virtual objects within the environment. By analyzing the physical characteristics of objects, such as their material composition or structural properties, augmented reality systems can simulate realistic interactions. For instance, virtual objects may bounce off a solid surface or pass through a transparent material based on their defined properties.

These object relationships and properties enable dynamic and interactive experiences in augmented reality. Users can manipulate virtual objects through gestures or touch, triggering responses and animations based on their interactions. Additionally, the relationships between objects and their properties can be leveraged to create location-based events or triggers, offering personalized and context-aware experiences.

By establishing and managing object relationships and properties, augmented unification provides users with a seamless integration of virtual and real world elements, resulting in immersive and engaging augmented reality experiences.

In augmented unification, location services and location intelligence may further be used to enhance the contextual awareness and immersive nature of augmented reality experiences. These technologies leverage various data sources, such as Global Positioning System (GPS) coordinates, geofencing, spatial data, and other location data to provide real-time information about the user's environment.

By utilizing location-based data, augmented reality applications can establish a spatial context for virtual objects and their interactions with the physical world. This context allows for a deeper understanding of the relationships between virtual objects and their surroundings. For example, virtual objects can be anchored to specific geographic coordinates or aligned with real world landmarks, enhancing their integration and believability.

Location services enable augmented reality applications to offer users valuable information about their surroundings. This includes points of interest, nearby landmarks, and relevant contextual details. By overlaying this information onto the user's real world view, augmented reality enhances their understanding and navigation of the environment.

Geofencing, a technique that defines virtual boundaries within physical spaces, is another powerful tool for location-based augmented reality. It allows applications to trigger specific events or content when users enter or exit predefined areas. For instance, an augmented reality game could activate a virtual challenge when the user enters a designated geofenced location.

Spatial data, such as maps, floor plans, or 3D models, further contribute to the location intelligence in augmented unification. By incorporating these data sources, applications can accurately depict and align virtual objects with their physical counterparts, ensuring a seamless blending of the virtual and real worlds.

The integration of location services and location intelligence in augmented unification offers users a heightened sense of situational awareness and a more immersive experience. It allows virtual content to be precisely positioned and contextualized within the user's surroundings, providing real-time information and enhancing interactions with the environment. Whether it's exploring points of interest, receiving navigation assistance, or triggering location-based events, location services and location intelligence enhance the overall quality and functionality of augmented reality applications.

In the realm of augmented unification, contextual awareness plays a crucial role in creating immersive and personalized augmented reality experiences. Contextual awareness involves understanding the situational context of a user's actions, events, or decisions and leveraging this information to provide relevant and meaningful information. For example, contextual awareness in augmented unification may involve the integration of location intelligence, object relationships learned from content, and/or computer vision to provide personalized and relevant information to users. By understanding the user's context and leveraging this information, augmented reality applications can deliver interactive and engaging experiences that enhance their understanding of the world around them.

One aspect of contextual awareness in augmented unification is the integration of location intelligence. By utilizing location-based data, such as GPS coordinates, geospatial information, and spatial context, augmented reality applications can provide real-time and location-specific information to users. This could include points of interest, directions, and contextual details about nearby objects or landmarks. By understanding the user's location, the application can overlay virtual content onto the real world in a way that is meaningful and relevant to their surroundings.

Additionally, contextual awareness considers other relevant factors such as time of day, weather conditions, user preferences, and historical data. By incorporating these factors, augmented reality applications can adapt their content, behavior, and interactions to provide a more personalized and tailored experience. For example, an augmented reality app for travel might provide recommendations for nearby attractions based on the user's preferences and the current time of day.

Object relationships also contribute to contextual awareness in augmented unification. By understanding how virtual objects relate to one another and their interactions with the physical environment, augmented reality applications can create dynamic and interactive experiences. These object relationships allow virtual objects to interact with real world objects, respond to user input, or trigger events based on their context within the environment.

Furthermore, computer vision technology plays a vital role in contextual awareness by analyzing and interpreting the real world environment. By utilizing computer vision algorithms, augmented reality applications can recognize objects, surfaces, and patterns in the user's surroundings. This information is then used to seamlessly integrate virtual content into the physical environment, creating a cohesive and realistic augmented reality experience.

In augmented reality technology, computer vision plays a crucial role in supporting augmented unification. By leveraging computer vision, augmented reality games can analyze the real world environment and seamlessly integrate digital content with the physical world. Computer vision algorithms are employed to recognize and interpret various aspects of the real world environment, such as objects, surfaces, and patterns. This information is then utilized to overlay digital content in a manner that appears anchored or integrated within the physical surroundings. This integration creates a sense of unity between the virtual and real elements, enhancing the immersive experience for players.

Computer vision also enables augmented reality games to recognize and track the movements and actions of players. By continuously analyzing visual data in real-time, the game can respond to the user's interactions and adjust the placement and behavior of virtual objects accordingly. This interactivity enhances the engagement and enjoyment of the gaming experience.

It is important to note that computer vision alone is not sufficient to create augmented reality. Instead, it is one of the critical technologies combined with other concepts and data that enable the contextual awareness and object relationships necessary for augmented reality applications. By utilizing computer vision alongside other components, augmented reality games can provide users with a captivating and immersive world where digital and physical elements seamlessly coexist.

Semantic distance is a concept used in augmented unification and augmented reality to measure the conceptual similarity or dissimilarity between objects or entities in a virtual environment. It involves assessing the relationship between different objects or elements based on their semantic properties, such as their attributes, characteristics, or meanings.

In the context of augmented unification, semantic distance is used to determine the relevance and appropriateness of virtual objects or information overlaid onto the real world. By considering the semantic distance between virtual and real world objects, augmented reality applications can provide a more contextually meaningful and cohesive experience.

Semantic distance helps ensure that virtual objects or information align with the user's environment and intention. For example, if a user is seeking information about a specific landmark, the augmented reality application can use semantic distance to identify and display related information or virtual objects that are conceptually connected to the landmark. This could include historical facts, nearby attractions, or user-generated content associated with the landmark.

By utilizing semantic distance, augmented unification can create a more immersive and seamless augmented reality experience. It enables the application to intelligently determine which virtual objects or information are most relevant and meaningful in a given context, enhancing the user's understanding and interaction with their environment.

Additionally, semantic distance can be leveraged to support interactive and dynamic experiences in augmented reality. By analyzing the semantic relationships between objects, the application can enable users to interact with virtual objects in a way that aligns with their conceptual understanding. For instance, users may be able to manipulate or rearrange virtual objects based on their semantic connections or properties, providing a more intuitive and immersive interaction.

The use of semantic distance in augmented unification and augmented reality enhances the contextual relevance and coherence of virtual content with the real world. By considering the semantic relationships between objects and leveraging this information, augmented reality applications can deliver more meaningful and engaging experiences for users.

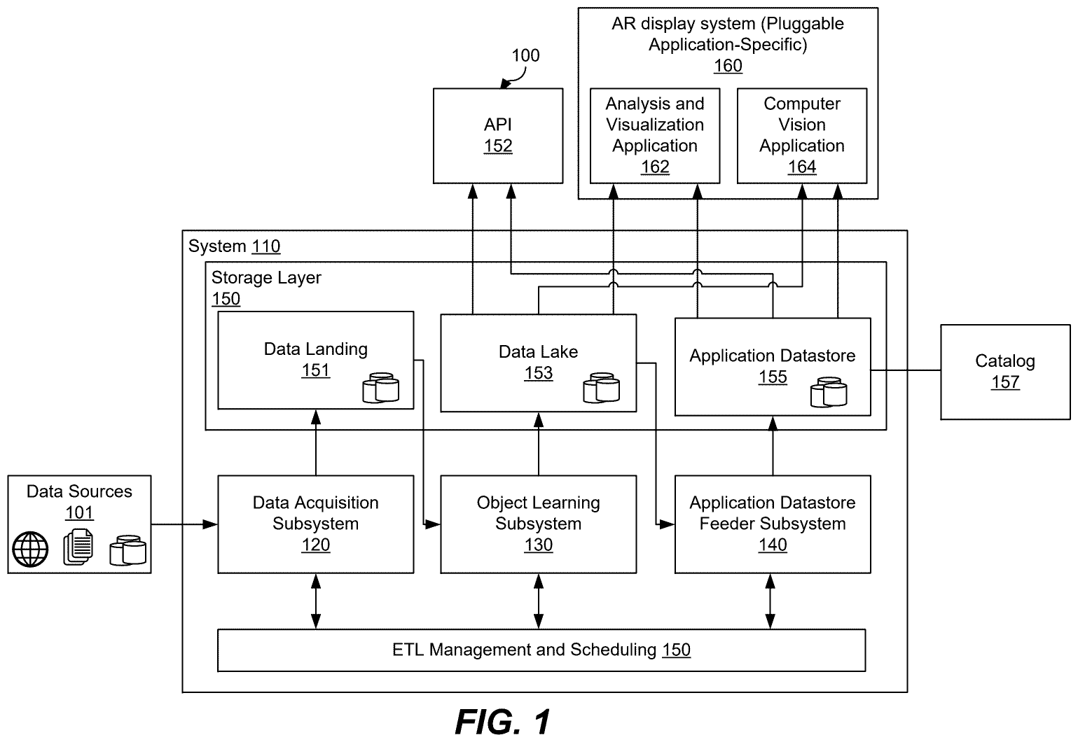

FIG. 1 illustrates an example of a system environment 100 for learning relationships and properties of data objects for context-aware AU systems for intelligent interactions between objects in an AR display. The Real World (RW) has real world objects each having properties such as color, shape, size, density, sound, and/or other characteristics that can be measured, quantified, or otherwise observed. Put another way, a real world object is one that exists in the real world. An AR display includes real world objects augmented with virtual objects. A virtual object is digital content that is generated for output (including visual, audio, and/or haptic output) via an electronic interface. A virtual object may visually depict a real world object in a realistic or non-realistic way, or may simply be content such as text, a logo, or other visual depiction that is displayed via the electronic interface. As used herein throughout, the terms “real world” and “physical world” will be used interchangeably.

When the virtual object is generated to depict a real world object, the virtual object may inherit one or more properties and/or relationships of the real world object. For example, the system may assign one or more learned properties and/or relationships of the real world object to the virtual object. A virtual object may also have its own properties and relationships in addition to or instead of those inherited from a real world object. For example, two emoji images may be deemed to be closely related to one another because they are often used together in social media posts or used in the same context as one another.

Each real world object and each virtual object may be electronically represented as a data object, which is electronic information that can be stored and accessed by a computer. Each data object may have properties that are based on the real world or virtual object that it represents. A data object property may further include behavioral properties, such as actions that the data object may take.

The system may acquire content that includes data objects that represent real world or virtual objects and learn properties and/or relationships between the data objects. For example, text from a webpage may include the words “basketball,” “player,” and “scoreboard” among other words. The webpage may further include images such as a crowd of people and icons of a basketball. Some of the data objects in the content represent real world objects (such as basketball, player, scoreboard, and crowd) while other data objects represent virtual objects (such as icons). The system may acquire and learn from the content, such as by understanding that the words “basketball,” “player,” “scoreboard,” and “crowd”, as well as the icon are used within the same context across different webpages and/or are used within the same webpage. Of course, there will be many other types of content other than websites relating to different types of subject matter and having different data objects. Properties of the objects may be learned from metadata or other information associated with the content. For example, the content may be associated with a specific geolocation, in which case contextual geolocation data may be associated with the data objects in the content.

The system may learn object properties and relationships from online content such as websites, training data, data APIs exposed by content services including social media platforms, and/or other sources. These learned properties and relationships may enrich AU systems and generative AI systems. For example, learned properties and relationships of objects may enable AU systems to identify relevant virtual objects to overlay onto recognized real world objects by virtue of their relationships and respective learned properties.

Furthermore, the learned properties and relationships of objects may enable AU systems to program virtual objects to behave in ways that suit the context of the real world on which they are overlaid. By leveraging the learned properties and relationships, AU systems may provide improved AR displays that are based on real world context that is learned by the system. Learned properties and relationships of objects may also enable generative AI systems that use Large Language Models (LLMs) to use programmatically configured inputs, such as prompts, for relevant content generation. For example, the system may be used to generate informative context-based prompts based on semantic and other relationships between various objects. Generative AI systems may be provided with improved semantic relationships between objects, enabling a deeper understanding of content to generate.

When the improved AU systems and generative AI systems are combined, these new systems may enable generative AR displays in which new virtual objects may be generated to be overlaid onto the real world.

The system may continuously acquire and learn from content. In this way, the system may adapt in real-time to new properties and relationships, enabling specifically configured AR and/or generative AI systems that are based on current real world context. For example, as terminologies, images, icons, and other content changes, the system is able to keep up with these changes to continue to learn object properties and relationships.

The system environment 100 may include a plurality of data sources 101, a context-based Augmented Unification (AU) system 110, a plurality of client systems 180, and/or other features. Each data source 101 is a source of content, which is electronic data that may be transmitted over a communication network and/or stored in a memory. Examples of data sources 101 include, without limitation, websites (webservers that provide websites), APIs that expose API calls to download content, databases, and files. Data sources 101 may be operated by various types of entities such as website operators or owners, social media platforms, streaming platforms, and/or other types of entities that provide content, usually via a network.

Examples of content include, without limitation, text, still or video images, electronic documents, audio, location data such as geospatial coordinates or map data, and/or other types of data. The content may be structured and/or unstructured. Structured content is data that is organized in a predefined format that can be used to search and extract data. Examples of the predefined format for structured content include spreadsheets, tables, extensible Markup Language (XML), key-value paired data such as Javascript Object Notation (JSON), relational databases, and/or other types of formats that organize data. On the other hand, unstructured data is not organized in a predefined format. The content, whether structured or unstructured, may include websites, documents, database records, streamed content, downloaded content, and/or other types of content that can be accessed via a communication network and/or from storage.

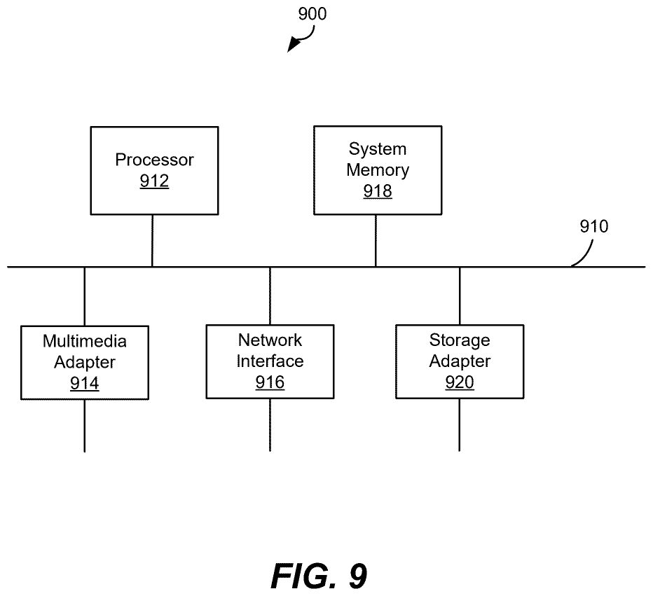

The context-based AU system 110 may acquire content from the data sources 101, learn relationships between data objects based on the content, and store and transmit the relationships via an API 152 and/or one or more end user applications 170. The system 110 may include a data acquisition subsystem 120, an object learning subsystem 130, an application datastore feeder subsystem 140, a storage layer 150, and/or other components. Each of the subsystems 120, 130, and 140 may be implemented in software and/or hardware, such as one or more components of the computer system illustrated in FIG. 9. The storage layer 150 may include a plurality of datastores that store data, either temporarily or persistently. Examples of the datastores include a data landing 151, a data lake 153, and an application datastore 155.

### Data Acquisition

The data acquisition subsystem 120 may acquire content from the data sources 101 and store the content in the data landing 151. For example, the data acquisition subsystem 120 may obtain content such as documents, text, and images, and/or otherwise access the content. The data acquisition subsystem 120 may do so via, without limitation, web scraping, accessing external Application Programming Interfaces (APIs), and directly downloading the content from the data sources 101.

The data acquisition subsystem 120 may acquire content and pre-process the acquired content for learning object properties and relationships. use image recognition algorithms to establish correlations between images and text, enabling a deeper understanding of the objects within the images. The data acquisition subsystem 120 may use optical character recognition (OCR) technology to extract text embedded within images, further facilitating the correlation between recognized objects and textual information to establish relationships between objects contained in an image and text or other content included in or with the image.

The data acquisition subsystem 120 may identify the need for additional context related to specific objects. For example, the data acquisition subsystem 120 may conduct directed searches to acquire supplementary information, allowing for a more comprehensive understanding of the objects in question. Furthermore, the data acquisition subsystem 120 facilitates reinforcement learning, where insights gained from previous data ingestion processes are utilized to enhance future object correlation. By leveraging this knowledge, contextual data can be effectively utilized to drive more accurate and meaningful object correlations.

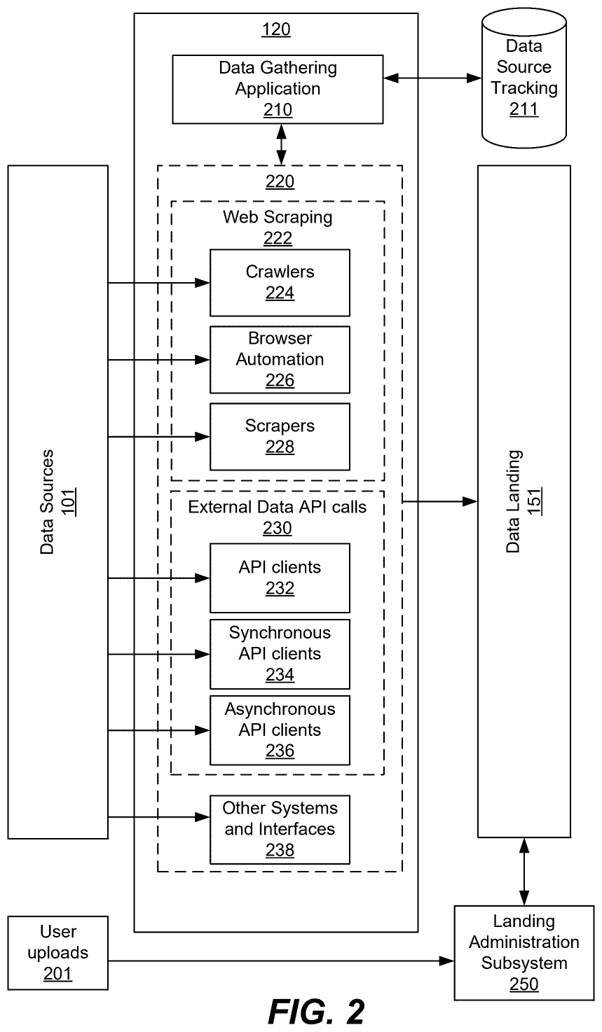

The data acquisition subsystem 120 may use a topology/relationship schema specifically to house the learned properties and relationships. The schema establishes a structured framework for capturing and representing the learned properties of, and relationships between, objects analyzed from the acquired content. By defining a comprehensive topology, the system can better understand and interpret the interactions and dependencies between objects, leading to more immersive and seamless experiences. Examples of the operation of the data acquisition subsystem 120 are described in more detail with respect to FIG. 2.

### Learning Properties and Relationships of Objects

The object learning subsystem 130 may access content, such as content acquired by the data acquisition subsystem 120, and learn properties of and relationships among data objects in the content. A data object is a representation of an object. The representation can include text such as the word “bell” that represents a bell, an image such as an image of the bell, audio such as a sound of a bell, and/or other types of representations that can be included in the content. The object learning subsystem 130 may identify the data object from the content. For example, if the content includes text, the object learning subsystem 130 may use Natural Language Processing (NLP) techniques such as entity recognition to identify the data object from text. If the content includes an image, the object learning subsystem 130 may use image recognition techniques to identify the data object in the image. Once data objects are recognized from the content, the object learning subsystem 130 may learn relationships between different data objects. These relationships may be stored in the data lake 153.

To support augmented unification, the object learning subsystem 130 may employ, without limitation, topic modeling, entity extraction, computer vision, relationships and contextual awareness, semantic distance, and object behavior definitions.

The object learning subsystem 130 may use topic modeling to identify and extract relevant topics or themes from the content. Topic modeling is a statistical technique that may identify topics in the content. For example, words like “engine” and “tire” are statistically more likely to appear in car-related topics than pet-related topics. This enables a deeper understanding of the content and context surrounding the objects, contributing to more accurate correlations and meaningful interactions.

The object learning subsystem 130 may use entity extraction to identify and extract specific entities, such as objects, locations, or people, from unstructured text or multimedia sources. Entity extraction is an NLP task that identifies and categorizes named entities in text. A named entity is a word or phrase that refers to specific object. This allows for a more precise recognition and correlation of objects within the augmented reality environment.

The object learning subsystem 130 may use computer vision to recognize and interpret objects in images. Computer vision extracts useful information from images (still or video). Through advanced image recognition techniques, objects can be accurately identified, leading to more precise correlations and augmented reality experiences.

The object learning subsystem 130 may leverage relationships between previously seen objects and incorporate contextual awareness, such as location intelligence and time of day, to enhance object correlations. This contextual understanding provides a richer and more immersive augmented reality experience.

The object learning subsystem 130 may use semantic distance to measure the similarity or relatedness between objects. Semantic distance is a measure of the closeness of objects found in the content. Semantic distance may include, for example, word-word semantic distance, image object semantic distance, and word-image object semantic distance. By quantifying the semantic relationships between objects, more meaningful correlations can be established.

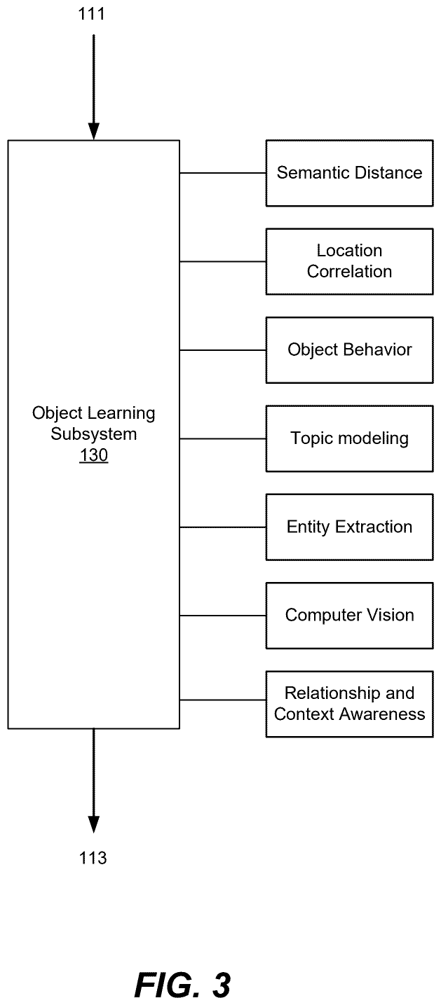

The object learning subsystem 130 may use object behavior definition to define what a given object is allowed or expected to do based on its identity and context. This ensures that object interactions and behaviors align with the intended user experience, creating more realistic and engaging augmented reality scenarios. Examples of the operations of the object learning subsystem 130 are described in more detail with respect to FIG. 3.

The application datastore feeder subsystem 140 may access the data lake 153 and load records into the application datastores 155, from which end user applications 160 may access.

### Data Access and Implementations by Client Programs

The end user applications 160 may include analysis and visualization applications 162, computer vision applications 164, and/or other end user applications.

The analysis and visualization applications 162

The computer vision applications 164

To enhance augmented unification on the client side, various technologies and functionalities will be leveraged. These include API for Data Access: A dedicated API will be developed to provide seamless access to the augmented unification data. This API will enable clients to retrieve relevant information and interact with the augmented reality environment in real-time. The clients will have the capability to provide inputs in the form of images, networked locations of content (URIs), or identification of specific objects. This allows for dynamic and personalized interactions within the augmented reality experience. The system 110 will generate outputs in response to client inputs. These outputs will include contextual information, location intelligence, relationship data, and computer vision data. For example, clients will receive information about the context and relationships to other gamers, objects, and villages, as well as details about recognized objects and extracted text through OCR.

Non-limiting examples of implementations of the system 110 may include AU gaming and LLM (Language Model) training/fine-tuning. In AU gaming, clients can immerse themselves in interactive augmented reality gaming experiences where they can explore virtual worlds, interact with objects, and engage with other gamers. LLM training/fine-tuning involves the integration of Natural Language Processing methods pre-trained LLMs with APIs to improve language models by leveraging grammar correction, context, and definitions provided by the LLMs.

FIG. 2 illustrates an example of a schematic architecture 200 of a data acquisition subsystem 120 that acquires data from various data sources for learning data object properties and relationships. The data acquisition subsystem 120 may include a plurality of data gathering systems 220, which includes web scraping 222, external data API clients 230, and/or other systems and interfaces 238 for acquiring content from data sources 101.

In some implementations, ETL Management and Scheduling (ETMS) 150 may execute one or more of the data gathering systems 220 to obtain content from one or more data sources 101. For example, the data gathering application 210 may order a search to find content that includes a data object for learning properties and/or relationships of the data object from the found content.

In some implementations, the data gathering systems 220 may execute autonomously and continuously to acquire content from the data sources 101. New data sources 101 may be added to expand the known sources of content. Through continuous acquisition and/or dynamic addition of data sources 101, the object learning subsystem 130 is able to learn from content that is available in real-time. The data acquisition subsystem 120 may track the known data sources 101 (such as APIs, databases, and websites) and will record the last search date and time. Manual uploads by operators may also be used.

Web scraping 222 may include downloading content from websites and other accessible documents.

External data API calls 230 are executable calls to external APIs exposed by various data sources 101. The API calls 230 may be made by API clients 232, synchronous API clients 234, and asynchronous API clients 236.

The API clients 232 may _.

A synchronous API client 234 is a client that makes an API call that blocks the execution of the calling thread until the API call has returned a response. This means that the calling thread cannot do anything else until the API call has finished. Synchronous API clients 234 may be used for time-sensitive requests to obtain content.

An asynchronous API client 236 is a client that makes an API call that does not block the execution of the calling thread until the API call has returned a response. In this case, the calling thread may execute other tasks while the API call is in progress. Asynchronous API clients 236 may be used when the response is not time sensitive.

Content obtained by the data acquisition subsystem 120 may be stored in the data landing 151. The data landing 151 may store various data formats of content acquired from the data sources 101. The data landing 151 is a datastore that is configured to store various file formats of content may include a file-based storage solution, which may be hosted by a serverless computer system that provides hosted storage solutions. This is the main collection point of raw data coming into the AU data library. Separate from the data lake 153, where processed content is stored, the data landing 151 stores any format or sized datasets. The content may include spatial data as well as non-spatial data. From the data landing 151, data will be pre-processed and packaged for processing in the object learning subsystem 130.

The data landing administration subsystem 250 may manage the content stored within the data landing 151. The data landing administration subsystem 250 may receive user uploads 201 and store them in the data landing 151. The data source tracking 211 may store data sources 101 from which content is acquired. The data gathering system 220 may use the data source tracking 211 to identify the data sources 101 from which to acquire content.

FIG. 3 illustrates an example of a schematic architecture of an object learning subsystem 130 for learning data object properties and relationships. In some examples, the object learning subsystem 130 may execute on demand as in response to an event, such as when content is acquired and stored in the data landing 151 for learning data object relationships and/or properties. This event-driven orchestration will reduce server uptime while maintaining continuous content acquisition and learning. In some examples, the object learning subsystem 130 may be executed in a containerized environment in which software and its dependencies are run in preconfigured containers. One example of a containerized environment is the DOCKER environment, although other containerized environments may be used.

Batch data processing will run through raw data added to the data landing zone to determine the object properties and to establish relationships between objects. Natural Language Processing and other data science methodology will be used to analyze the relationships between objects. Apache Spark will be used for big data processing, allowing large datasets to be easily digested and analyzed. Apache Sedona will be used to perform similar processing on large geospatial databases. This processing component is at the heart of the AU Data Library. Each process will move data from a raw state in the data landing into the data lake, while identifying relationships between objects. The data processing component involves developing data engineering processes that find and expand on data relationships. Semantic relationship discovery and semantic distance will power the data processing component. By analyzing the relationship between objects and their distance within large bodies of text, we will discover data relationships automatically.

Spatially enabling the object relationships is the next level of object relationships. By placing objects within a physical distance as well as a semantic distance, the data processes allows the AU Data Library to offer data insights never before seen.

The main function of this layer is to perform extraction, transformation and migration of data from source to the final destination across the data storage layer. Spatial Data Processes: these processes will tie data objects to the real world using location, as well as use location units to add contextual awareness. These spatial data processes will represent spaces both indoor and outdoors.

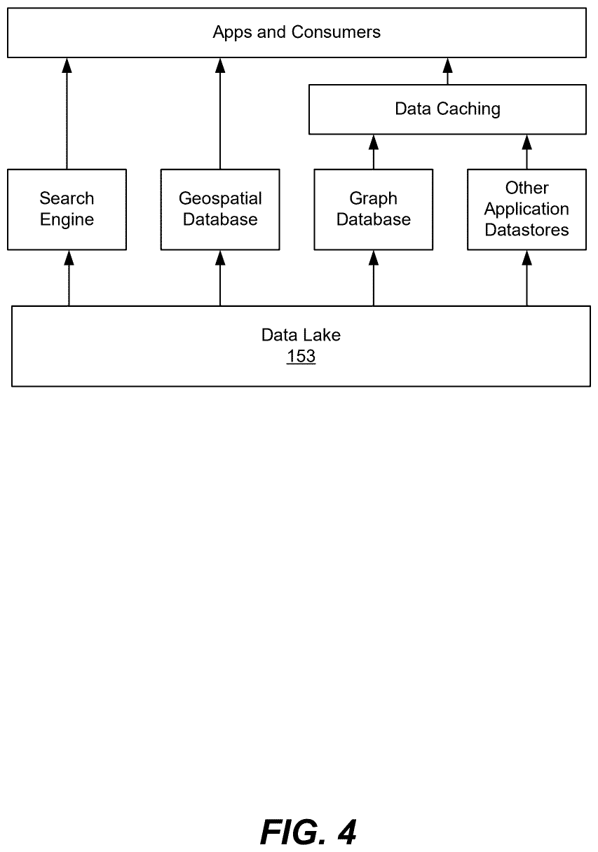

FIG. 4 illustrates an example of a schematic architecture of a data lake 153 for processing content from the data landing 151. Data storage, data retrieval and an integrated search engine will be at the heart of the AU Data Library. The Data Lake is the core of the component, a central repository of both structured and unstructured data, meaning there are data files and databases working together to store specific types of data. For the types of object relationships the AU Data Library will depend on, a graph data type as well as relational databases will be used. Spatial data, which has both graph data tendencies and relational tables, will benefit from this mixed data storage approach as well. Once relationships are established, the entities and relationships will be written to a graph database. The accompanying search engine, which will reference the graph database, will be continuously updated to provide search results, and a cache layer will be implemented to enable instant retrieval of application data.

The data lake will be a living component of the applications, and object relationships and properties will be continuously evaluated and updated. In addition, it will store mesh data and imagery data from the applications that will not be processed as a part of the data lake. The data lake will have multiple components, including spatial databases, graph databases, file-based storage, and a search engine.

In low-latency environments, a simplified database file will be available for applications. This file-based database will be continuously updated and made available to applications for download to support local queries. The data lake 153 acts as a central repository of structured and unstructured datasets regardless of the target domain or use case. The search engine may provide search-like functionality to the AU data library. In some cases, it may also be used to provide analytics and to power other services based on the elastic ecosystem.

Application-specific data stores will provide a more specialized storage engines for specific use cases.

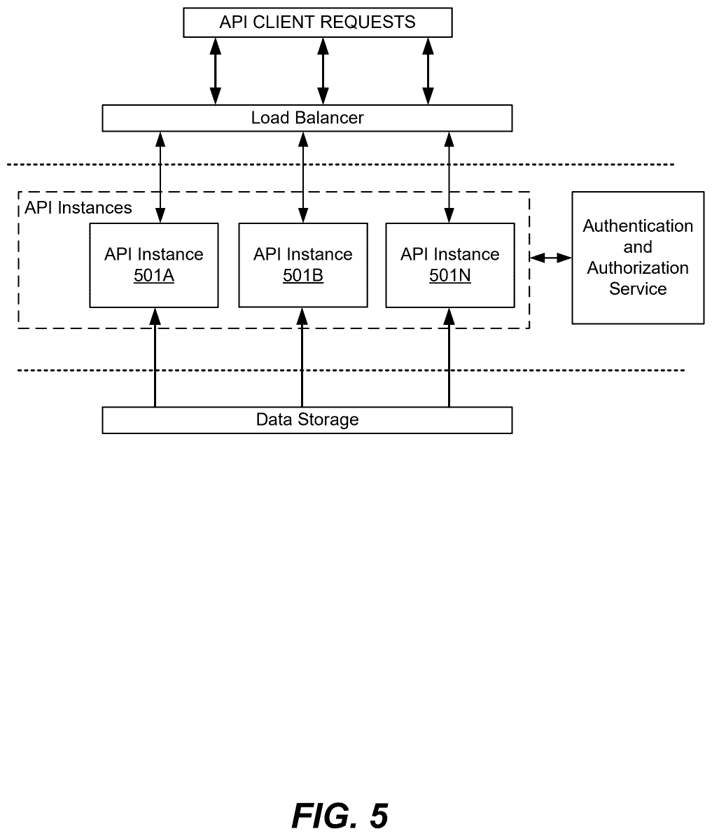

FIG. 5 illustrates an example of a schematic architecture of an interface for the learned data objects for AR applications. The intra-process data communication as well as the inter-application communication that will power the AU is a unique tool, with lots of potential for IP development and copyright protection. While APIs themselves don't often get patent protection, when paired with unique data processes and hardware they are eligible for patents. Given the AU's patent status, this may include these APIs. A REST API may include an external REST interface for application communication and internal endpoints for intra-component conveyance of data and events. The API may be housed in a containerized environment and will have constant uptime. Token-based authentication may be used to ensure the data is safe and secure.

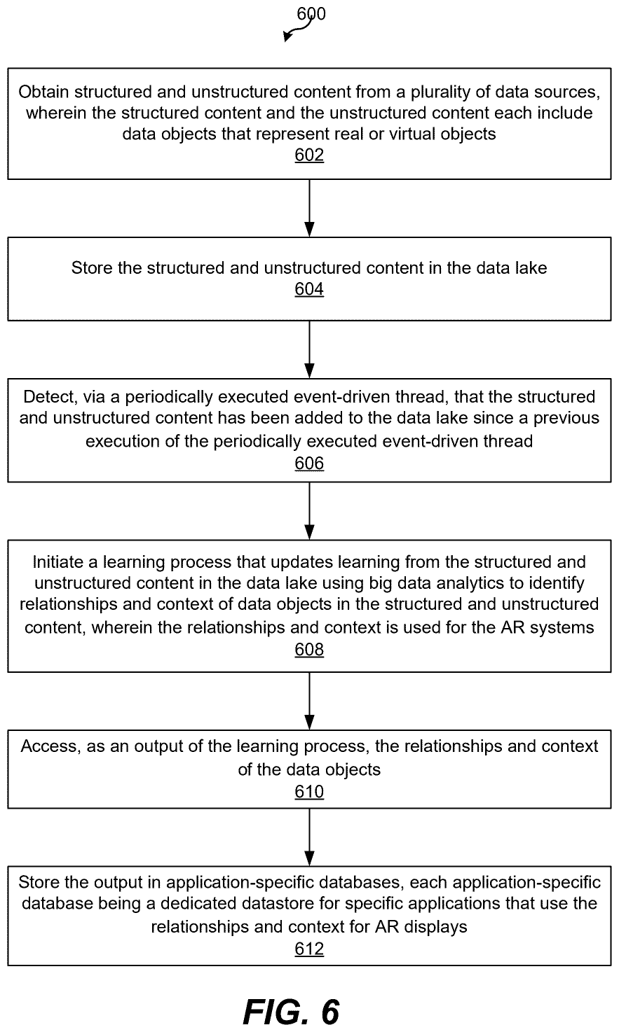

FIG. 6 illustrates a flowchart of an example of a method 600 of acquiring content and storing learned augmented unification data from the content in a storage architecture that enables efficient processing.

At 602, the method 600 may include obtaining structured and unstructured content from a plurality of data sources, wherein the structured content and the unstructured content each include data objects that represent real or virtual objects.

At 604, the method 600 may include storing the structured and unstructured content in the data lake, such as data lake 153.

At 606, the method 600 may include detecting, via a periodically executed event-driven thread, that the structured and unstructured content has been added to the data lake since a previous execution of the periodically executed event-driven thread.

At 608, the method 600 may include initiating a learning process that updates learning from the structured and unstructured content in the data lake using big data analytics to identify relationships and context of data objects in the structured and unstructured content, wherein the relationships and context is used for the AR systems.

At 610, the method 600 may include accessing, as an output of the learning process, the relationships and context of the data objects.

At 612, the method 600 may include storing the output in application-specific databases, each application-specific database being a dedicated datastore for specific applications that use the relationships and context for AR displays.

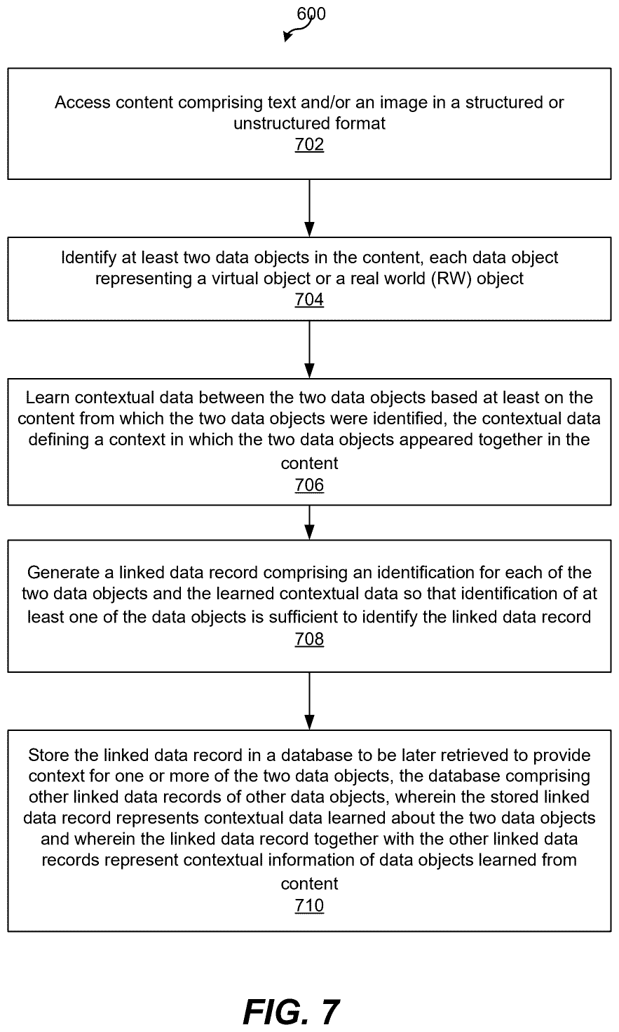

FIG. 7 illustrates a flowchart of an example of a method 700 of learning augmented unification data from content for augmented reality systems.

At 702, the method 700 may include accessing content comprising text and/or an image in a structured or unstructured format. Such accessing may be from a data lake such as data lake 153.

At 704, the method 700 may include identifying at least two data objects in the content, each data object representing a virtual object or a real world (RW) object.

At 706, the method 700 may include learning contextual data between the two data objects based at least on the content from which the two data objects were identified, the contextual data defining a context in which the two data objects appeared together in the content.

At 708, the method 700 may include generating a linked data record comprising an identification for each of the two data objects and the learned contextual data so that identification of at least one of the data objects is sufficient to identify the linked data record.

At 710, the method 700 may include storing the linked data record in a database to be later retrieved to provide context for one or more of the two data objects, the database comprising other linked data records of other data objects, wherein the stored linked data record represents contextual data learned about the two data objects and wherein the linked data record together with the other linked data records represent contextual information of data objects learned from content.

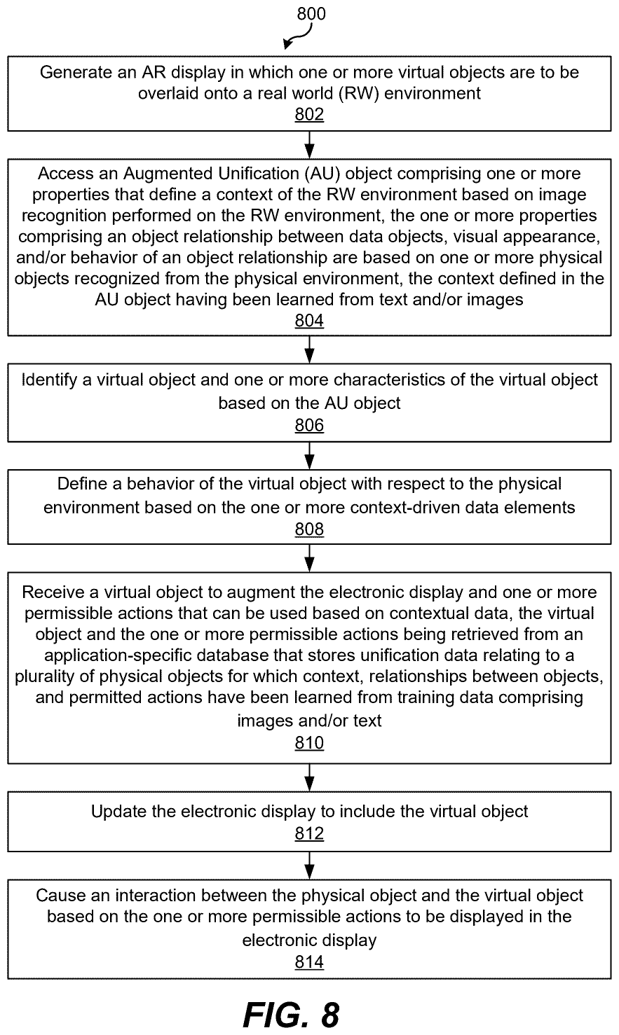

FIG. 8 illustrates a flowchart of an example of a method 800 of context-aware augmented reality using augmented unification data learned from content.

At 802, the method 800 may include generating an AR display in which one or more virtual objects are to be overlaid onto a real world (RW) environment.

At 804, the method 800 may include accessing an Augmented Unification (AU) object comprising one or more properties that define a context of the RW environment based on image recognition performed on the RW environment, the one or more properties comprising an object relationship between data objects, visual appearance, and/or behavior of an object relationship are based on one or more physical objects recognized from the physical environment, the context defined in the AU object having been learned from text and/or images.

At 806, the method 800 may include identifying a virtual object and one or more characteristics of the virtual object based on the AU object.

At 808, the method 800 may include defining a behavior of the virtual object with respect to the physical environment based on the AU object.

At 810, the method 800 may include receiving a virtual object to augment the electronic display and one or more permissible actions that can be used based on contextual data, the virtual object and the one or more permissible actions being retrieved from an application-specific database that stores unification data relating to a plurality of physical objects for which context, relationships between objects, and permitted actions have been learned from training data comprising images and/or text.

At 812, the method 800 may include updating the electronic display to include the virtual object.

At 814, the method 800 may include causing an interaction between the physical object and the virtual object based on the one or more permissible actions to be displayed in the electronic display.

FIG. 9 illustrates an example of a computer system 900 that may be implemented by devices illustrated in FIGS. 1-5. The computer system 900 may be part of or include the system environment 100 to perform the functions and features described herein. For example, various ones of the devices of system environment 100 may be implemented based on some or all of the computer system 900.

The computer system 900 may include, among other things, an interconnect 910, a processor 912, a multimedia adapter 914, a network interface 916, a system memory 918, and a storage adapter 920.

The interconnect 910 may interconnect various subsystems, elements, and/or components of the computer system 900. As shown, the interconnect 910 may be an abstraction that may represent any one or more separate physical buses, point-to-point connections, or both, connected by appropriate bridges, adapters, or controllers. In some examples, the interconnect 910 may include a system bus, a peripheral component interconnect (PCI) bus or PCI-Express bus, a HyperTransport or industry standard architecture (ISA)) bus, a small computer system interface (SCPI) bus, a universal serial bus (USB), IIC (I2C) bus, or an Institute of Electrical and Electronics Engineers (IEEE) standard 1384 bus, or “firewire,” or other similar interconnection element.

In some examples, the interconnect 910 may allow data communication between the processor 912 and system memory 918, which may include read-only memory (ROM) or flash memory (neither shown), and random-access memory (RAM) (not shown). It should be appreciated that the RAM may be the main memory into which an operating system and various application programs may be loaded. The ROM or flash memory may contain, among other code, the Basic Input-Output system (BIOS) which controls basic hardware operation such as the interaction with one or more peripheral components.

The processor 912 may control operations of the computer system 900. In some examples, the processor 912 may do so by executing instructions such as software or firmware stored in system memory 918 or other data via the storage adapter 920. In some examples, the processor 912 may be, or may include, one or more programmable general-purpose or special-purpose microprocessors, digital signal processors (DSPs), programmable controllers, application specific integrated circuits (ASICs), programmable logic device (PLDs), trust platform modules (TPMs), field-programmable gate arrays (FPGAs), other processing circuits, or a combination of these and other devices.

The multimedia adapter 914 may connect to various multimedia elements or peripherals. These may include devices associated with visual (e.g., video card or display), audio (e.g., sound card or speakers), and/or various input/output interfaces (e.g., mouse, keyboard, touchscreen).

The network interface 916 may provide the computer system 900 with an ability to communicate with a variety of remote devices over a network such as a communication network. The network interface 916 may include, for example, an Ethernet adapter, a Fibre Channel adapter, and/or other wired- or wireless-enabled adapter. The network interface 916 may provide a direct or indirect connection from one network element to another, and facilitate communication and between various network elements.

The storage adapter 920 may connect to a standard computer readable medium for storage and/or retrieval of information, such as a fixed disk drive (internal or external).

Other devices, components, elements, or subsystems (not illustrated) may be connected in a similar manner to the interconnect 910 or via a network such as a communication network. The devices and subsystems can be interconnected in different ways from that shown in FIG. 9. Instructions to implement various examples and implementations described herein may be stored in computer-readable storage media such as one or more of system memory 918 or other storage. Instructions to implement the present disclosure may also be received via one or more interfaces and stored in memory. The operating system provided on computer system 900 may be MS-DOS®, MS-WINDOWS®, OS/2®, OS X®, IOS®, ANDROID®, UNIX®, Linux®, or another operating system.

Throughout the disclosure, the terms “a” and “an” may be intended to denote at least one of a particular element. As used herein, the term “includes” means includes but not limited to, the term “including” means including but not limited to. The term “based on” means based at least in part on. In the Figures, the use of the letter “N” to denote plurality in reference symbols is not intended to refer to a particular number. For example, “114A-N” does not refer to a particular number of instances of 114, but rather “one or more.”

The serverless database and other datastores described herein may include, or interface to, for example, a MYSQL database, a POSTGRESQL database, an Oracle™ relational database sold commercially by Oracle Corporation. Other databases, such as Informix™, DB2 or other data storage, including file-based, or query formats, platforms, or resources such as OLAP (On Line Analytical Processing), SQL (Structured Query Language), a SAN (storage area network), Microsoft Access™ or others may also be used, incorporated, or accessed. The database may comprise one or more such databases that reside in one or more physical devices and in one or more physical locations. The database may include cloud-based storage solutions. The database may store a plurality of types of data and/or files and associated data or file descriptions, administrative information, or any other data. The various databases may store predefined and/or customized data described herein.

The systems and processes are not limited to the specific embodiments described herein. In addition, components of each system and each process can be practiced independently and separate from other components and processes described herein. Each component and process can also be used in combination with other assembly packages and processes. The flow charts and descriptions thereof herein should not be understood to prescribe a fixed order of performing the method blocks described therein. Rather the method blocks may be performed in any order that is practicable including simultaneous performance of at least some method blocks. Furthermore, each of the methods may be performed by one or more of the system components illustrated in FIGS. 1-5.

As will be appreciated based on the foregoing specification, the above-described embodiments of the disclosure may be implemented using computer programming or engineering techniques including computer software, firmware, hardware or any combination or subset thereof. Any such resulting program, having computer-readable code means, may be embodied or provided within one or more computer-readable media, thereby making a computer program product, i.e., an article of manufacture, according to the discussed embodiments of the disclosure. Example computer-readable media may be, but are not limited to, a flash memory drive, digital versatile disc (DVD), compact disc (CD), fixed (hard) drive, diskette, optical disk, magnetic tape, semiconductor memory such as read-only memory (ROM), and/or any transmitting/receiving medium such as the Internet or other communication network or link. By way of example and not limitation, computer-readable media comprise computer-readable storage media and communication media. Computer-readable storage media are tangible and non-transitory and store information such as computer-readable instructions, data structures, program modules, and other data. Communication media, in contrast, typically embody computer-readable instructions, data structures, program modules, or other data in a transitory modulated signal such as a carrier wave or other transport mechanism and include any information delivery media. Combinations of any of the above are also included in the scope of computer-readable media. The article of manufacture containing the computer code may be made and/or used by executing the code directly from one medium, by copying the code from one medium to another medium, or by transmitting the code over a network.

This written description uses examples to disclose the embodiments, including the best mode, and also to enable any person skilled in the art to practice the embodiments, including making and using any devices or systems and performing any incorporated methods. The patentable scope of the disclosure is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system, comprising:
a memory to store an AR application;
a processor programmed to execute the AR application and to:
generate an AR display in which one or more virtual objects are to be overlaid onto a real world (RW) environment;
access an Augmented Unification (AU) object comprising one or more properties that define a context of the RW environment based on image recognition performed on the RW environment, the one or more properties comprising an object relationship between data objects, visual appearance, and/or behavior of an object relationship are based on one or more physical objects recognized from the physical environment, the context defined in the AU object having been learned from text and/or images;
identify a virtual object and one or more characteristics of the virtual object based on the AU object;
define a behavior of the virtual object with respect to the physical environment based on the one or more context-driven data elements;
receive a virtual object to augment the electronic display and one or more permissible actions that can be used based on contextual data, the virtual object and the one or more permissible actions being retrieved from an application-specific database that stores unification data relating to a plurality of physical objects for which context, relationships between objects, and permitted actions have been learned from training data comprising images and/or text;
update the electronic display to include the virtual object; and
cause an interaction between the physical object and the virtual object based on the one or more permissible actions to be displayed in the electronic display.

2. The system of claim 1, wherein to cause the interaction, the processor is programmed to do so without input from a user

3. The system of claim 1, wherein to cause the interaction, the processor is programmed to do so in response to an input from a user,

4. The system of claim 3, wherein the input comprises a user interaction with the physical object

5. The system of claim 3, wherein the input comprises a user interaction with the virtual object.

6. An event-driven data ingestion system for continuous learning of contextual data for augmented reality (AR) systems, comprising:
a data lake;
a plurality of application-specific databases; and
a processor programmed to:
obtain structured and unstructured content from a plurality of data sources, wherein the structured content and the unstructured content each include data objects that represent real or virtual objects;
store the structured and unstructured content in the data lake;
detect, via a periodically executed event-driven thread, that the structured and unstructured content has been added to the data lake since a previous execution of the periodically executed event-driven thread;
initiate a learning process that updates learning from the structured and unstructured content in the data lake using big data analytics to identify relationships and context of data objects in the structured and unstructured content, wherein the relationships and context is used for the AR systems;
access, as an output of the learning process, the relationships and context of the data objects; and
store the output in application-specific databases, each application-specific database being a dedicated datastore for specific applications that use the relationships and context for AR displays.

7. The system of claim 6, wherein the data object includes an image of a real or virtual object.

8. The system of claim 6, wherein the data object includes text that identifies a real or virtual object.

9. The system of claim 6, wherein the data object includes sound that identifies a real or virtual object.

10. A system, comprising:
a processor programmed to:
access content comprising text and/or an image in a structured or unstructured format;
identify at least two data objects in the content, each data object representing a virtual object or a real world (RW) object;
learn contextual data between the two data objects based at least on the content from which the two data objects were identified, the contextual data defining a context in which the two data objects appeared together in the content;
generate a linked data record comprising an identification for each of the two data objects and the learned contextual data so that identification of at least one of the data objects is sufficient to identify the linked data record; and
store the linked data record in a database to be later retrieved to provide context for one or more of the two data objects, the database comprising other linked data records of other data objects, wherein the stored linked data record represents contextual data learned about the two data objects and wherein the linked data record together with the other linked data records represent contextual information of data objects learned from content.

11. The system of claim 10, wherein the two data objects each comprise text that represents a respective virtual object or RW object, and wherein to learn contextual data, the processor is programmed to:
determine a semantic distance between the text representing the respective RW objects to learn a level of similarity between the two data objects.

12. The system of claim 10, wherein the two data objects each comprise images that represents a respective virtual object or RW object, and wherein to learn contextual data, the processor is programmed to:
determine a number of times that the images are co-located within a same image across a plurality of content.

13. The system of claim 10, wherein to learn contextual data, the processor is programmed to:
identify a location associated with either of the two data objects and/or the content from which the two data objects were identified.

14. The system of claim 10, wherein to learn contextual data, the processor is programmed to:
identify a time and/or date associated with either of the two data objects and/or the content from which the two data objects were identified.

15. The system of claim 10, wherein the processor is programmed to:
receive an event-driven indication that new content comprising text and/or an image has been ingested to a data lake that stores text and/or images in a structured or unstructured format; and
trigger a learning process to learn the contextual data.
